(19) United States
(12) Patent Application Publication
(10) Pub. No.: US 2013/0256472 A1
(43) Pub. Date: Oct. 3, 2013

(54) CABLE HOLDER

(71) Applicants: LEI LIU, Shenzhen City (CN); GUO-YI CHEN, Shenzhen City (CN)

(72) Inventors: LEI LIU, Shenzhen City (CN); GUO-YI CHEN, Shenzhen City (CN)

(73) Assignees: HON HAI PRECISION INDUSTRY CO., LTD., Tu-Cheng (TW); HONG FU JIN PRECISION INDUSTRY(ShenZhen) CO., LTD., Shenzhen City (CN)

(21) Appl. No.: 13/558,353

(22) Filed: Jul. 26, 2012

(30) Foreign Application Priority Data
Mar. 29, 2012 (CN) 201210087697.1

(51) Int. Cl. F16L 3/10

(52) U.S. Cl. 248/74.4

(57) ABSTRACT

A cable holder includes a first holding unit, a second holding unit, and a fixing unit. The second holding unit hinges on the first holding unit to form an enclosed receiving space for receiving a cable. The fixing unit is connected to the first holding unit or the second holding unit to fix the cable holder on a casing. The first holding unit and the second holding unit are magnetic. The cable holder is utilized to hold and fix the cable stably on a casing.

### BACKGROUND

1. Technical Field

The present disclosure relates to a cable holder, and particularly to a cable holder for holding and fixing a cable on a casing.

2. Description of Related Art

There are many cables connected in a conventional server. Since the cables tend to be tangled together, the weight of the tangled cables may become a problem. The weight of all the tangled cables may be concentrated on one of the cables so the cable may split or be torn out. In addition, wires of the cables externally exposed can function as antennae so that other unwanted signals would be received by the cables and superimposed with signals transmitted in the cable. Therefore, the signals in the cable will suffer interference and distortion of the signals will occur.

Therefore, there is need for improvement in the art.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is an assembled diagram of an embodiment of a cable holder of the present disclosure.

FIG. 2 is an exploded diagram of the cable holder in FIG. 1.

FIG. 3 is a view of the cable holder in FIG. 1 in operation.

### DETAILED DESCRIPTION

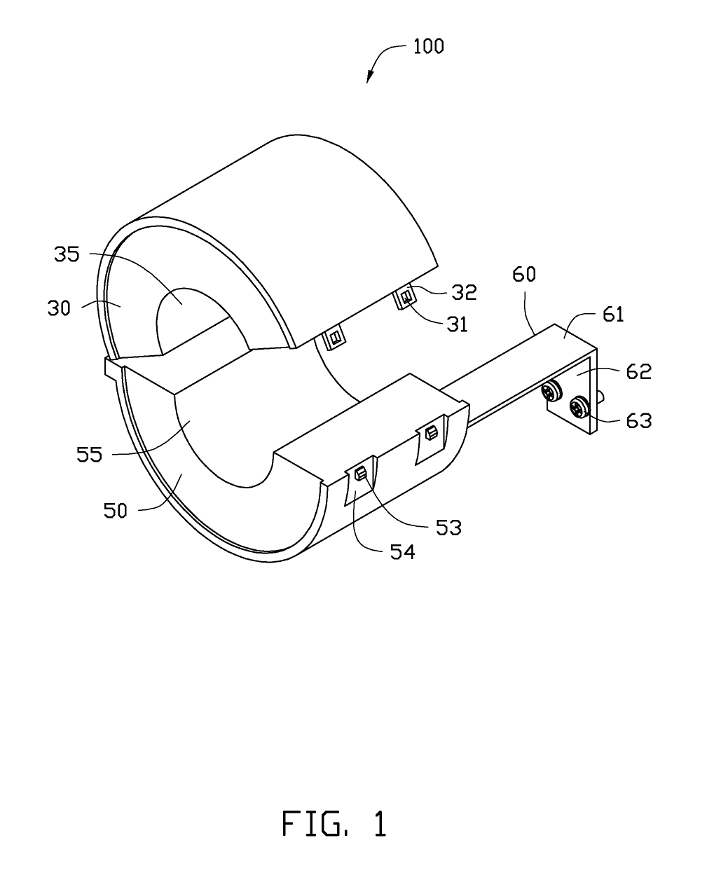

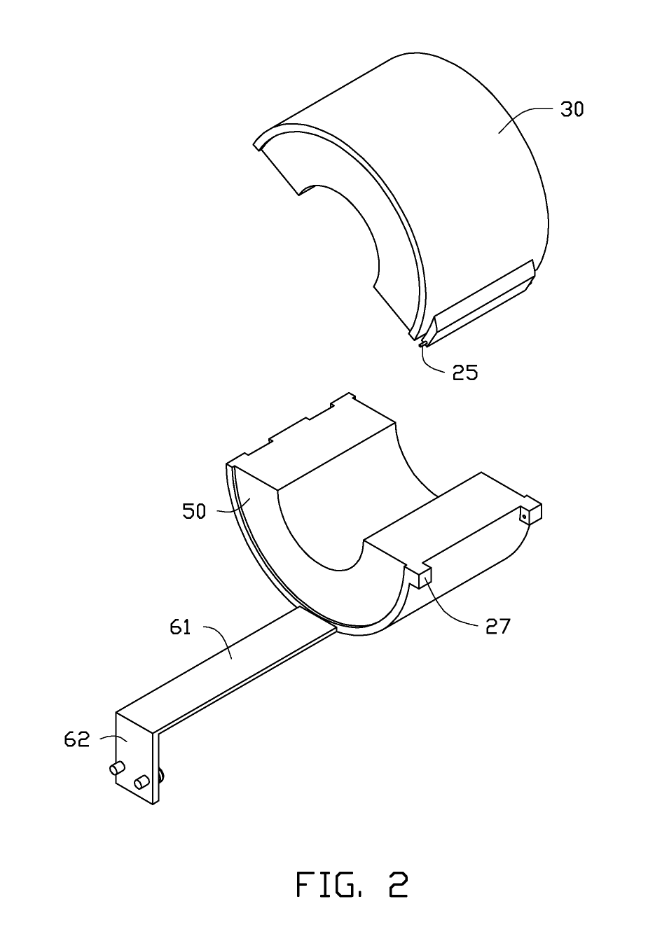

As shown in FIG. 1 and FIG. 2, an embodiment of a cable holder includes a first holding unit 50 and a second holding unit 30, wherein the first holding unit 50 and the second holding unit 30 are both magnetic. The cross section of the first holding unit 50 and the second holding unit 30 are both semicircular. The first holding unit 50 includes two ends, and the second holding unit 30 also includes two ends. A first end of the second holding unit 30 includes a rotatable spindle 25, and a first end of the first holding unit 50 includes two protrusion portions 27. The rotatable spindle 25 includes two ends, and each of the protrusion portions 27 includes an opening for receiving an end of the rotatable spindle 25. Therefore, the second holding unit 30 can hinge on the first holding unit 50 by means of the rotatable spindle 25.

An external surface of the first holding unit 50 includes two recesses 54 near a second end of the first holding unit 50. Each of the recesses 54 further includes a nub, dowel, or bump 53. The second holding unit 30 includes two miniature resilient frames or slices 32 protruding from an external surface of the second holding unit 30 near a second end of the second holding unit 30. Each of the frames 32 further includes a hole 31 for receiving a nub 53 so that each of the frames 32 can rise over and latch a nub 53 before sinking into one of the recesses 54, when the second holding unit 30 is closed onto the first holding unit 50. In other embodiments, the number of the recesses 54 can be only one or more than three, with a corresponding number of the frames 32.

The concavity in the first holding unit 50 is a first groove 55, and the concavity in the second holding unit 30 is a second groove 35. Both the first groove 55 and the second groove 35 are semi-cylindrical. Therefore, the first groove 55 and the second groove 55 can be united face to face to define a round receiving space for receiving a cable when the second holding unit 30 is covered on the first holding unit 50. In the embodiment, the magnetic materials of the first holding unit 50 and the second holding unit 30 can be ferrite material.

The cable holder 100 further includes a fixing unit 60 to fix the cable holder 100 on a casing. The fixing unit 60 includes an extending strip 61 and a fixing strip 62. The extending strip 61 extends from a side of the first holding unit 50. The fixing strip 62 extends from the distal end of the extending strip 61. The extending direction of the extending strip 61 is perpendicular to the extending direction of the fixing strip 62. The fixing strip 62 further includes two holes which may be threaded so that the cable holder 100 can be fixed on the casing by using screws 63. In another embodiment, the extending strip 61 can be extended from a side of the second holding unit 30.

An operating principle of an embodiment of the present disclosure is described as follows.

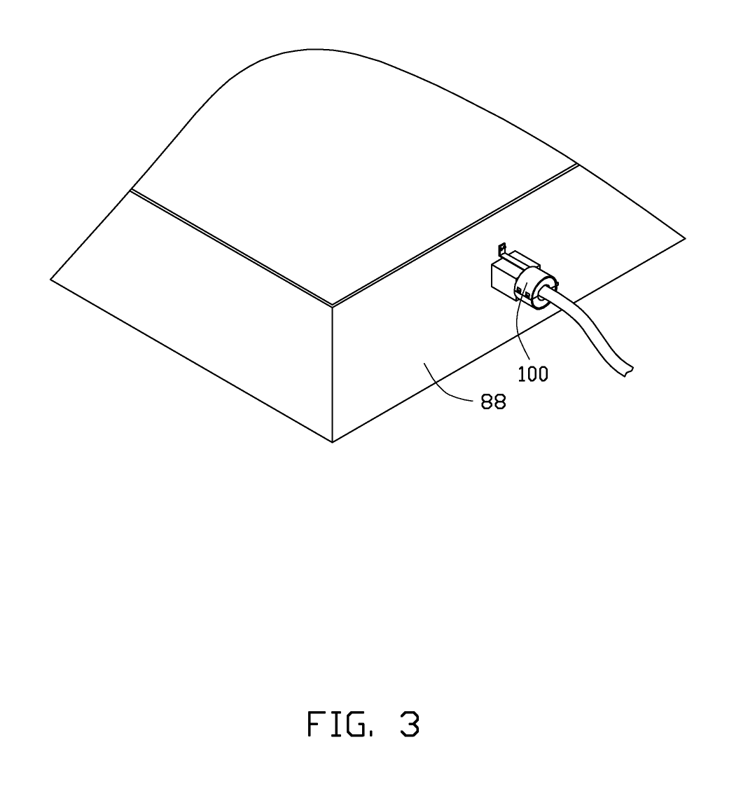

As shown in FIG. 1 and FIG. 3, the cable holder 100 is fixed on a server peripheral, or on a casing 88 of the server by means of the screws 63 and the holes of the fixing strip 62. In addition, the round receiving space formed by the first groove 55 and the second groove 35 is aligned with an opening of the server or its peripheral device. After the cable is connected to the interior of the server or the peripheral, the cable can be received in the round receiving space and the second holding unit 30 can be rotated to cover the first holding unit 50. The frames 32 of the second holding unit 30 are received in the recesses 54 of the first holding unit 50 after the nubs 53 of the recesses 54 are caught in the holes 31. Thus, an accidental separation between the first holding unit 50 and the second holding unit 30 is prevented.

Since the cable holder 100 can hold and fix the cable on the casing 88, a separation between the server and the cable is less likely, and the cable holder 100 also acts as a strain relief device, preventing any chafing of the cable and any flexing of the cable at the point of entry into the server which might lead to ultimate fatigue fracture. In addition, the first holding unit 50 and the second holding unit 30 are made of magnetic materials, so the cable holder 100 effectively shields the cable from external high and other frequency signals. Accordingly, the signals transmitted in the cable are not altered and the distortion of the signals would not occur.

While the disclosure has been described by way of example and in terms of one embodiment, it is to be understood that the disclosure is not limited thereto. On the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A cable holder for holding a cable, comprising:
a first holding unit;
a second holding unit configured to close onto the first holding unit to define a receiving space, together with the first holding unit, for receiving the cable, wherein the first holding unit and the second holding unit are made of magnetic material; and
a fixing unit connected to one of the first holding unit and the second holding unit and to mount the cable holder to a casing.

2. The cable holder of claim 1, wherein a first end of the second holding unit comprises a spindle having two ends, a first end of the first holding unit comprises two protrusion portions, and each of the protrusion portions comprises an opening to receive each of the two ends of the spindle to rotate the second holding unit.

3. The cable holder of claim 1, wherein a first external surface of a second end of the first holding unit comprises a recess with a nub in the recess, the second holding unit comprises a frame protruding from a second external surface of a second end of the second holding unit, and the frame comprises a hole for receiving the nub when the second holding unit is closed onto the first holding unit.

4. The cable holder of claim 1, wherein each of cross sections of the first holding unit and the second holding unit is a semi-ring.

5. The cable holder of claim 1, wherein the fixing unit further comprises:
an extending strip configured to extend from a side of one of the first holding unit and the second holding unit; and
a fixing strip configured to extend from the extending strip and comprising a threaded hole for fixing the cable holder on the casing.

6. The cable holder of claim 1, wherein the first holding unit comprises a first groove, the second holding unit comprises a second groove, and the first groove and the second groove are united face to face to define the receiving space when the second holding unit is closed onto the first holding unit.

7. A cable holder for holding and fixing a cable on a casing, comprising:
a first holding unit; and
a second holding unit configured to close onto the first holding unit to define a receiving space, together with the first holding unit, for receiving the cable, wherein the first holding unit and the second holding unit are made of magnetic material.
